(19) United States
(12) Patent Application Publication
(10) Pub. No.: US 2025/0086732 A1
(43) Pub. Date: Mar. 13, 2025

(54) Method and System for Continuous Construction and Operation of Very Large-Scale Solar Facilities

(71) Applicant: Black & Veatch Holding Company, Overland Park, KS (US)

(72) Inventors: Ryan J. Pletka, Overland Park, KS (US); Tyler Parker, Overland Park, KS (US); Brandon Close, Overland Park, KS (US)

(21) Appl. No.: 18/882,964

(22) Filed: Sep. 12, 2024

Related U.S. Application Data
(60) Provisional application No. 63/582,393, filed on Sep. 13, 2023.

(51) Int. Cl. G06Q 50/08; G06Q 10/30; G06Q 30/018; H02S 50/00

(52) U.S. Cl. CPC G06Q 50/08; G06Q 10/30; G06Q 30/018; H02S 50/00

(57) ABSTRACT

A method for continuously and perpetually designing, building, and operating a very large solar power facility so as to minimize planning, construction, and operation costs.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/582,393; titled “Method and System for Continuous Construction and Operation of Very Large-Scale Solar Facilities”; and filed Sep. 13, 2024. The Provisional Application is hereby incorporated by reference, in its entirety, into the current patent application.

### BACKGROUND

Increased awareness of global warming, falling costs for photovoltaic panels, and enhanced renewable energy incentives have increased the demand for utility-scale solar facilities (also commonly referred to as “solar farms”). The U.S. Energy Information Administration (EIA) estimates that solar is now the leading source of new electricity generation capacity in the United States, accounting for approximately 40% of new energy capacity, ahead of wind, natural gas, coal, and all other sources.

But building a solar farm is still expensive and time consuming, requiring completion of detailed construction plans and environmental studies, land acquisition, approval from various state and local government agencies, and procurement and installation of the solar panels. These constraints increase the costs of solar farms and slow the switch to solar energy. Moreover, once built, the performance of solar farms slowly degrade as the performance of the solar panels degrade or equipment fails. But replacing degraded solar panels is typically too costly and time-consuming with current methods.

### SUMMARY OF INVENTION

The present invention solves these and other problems and provides a distinct advance in the art of solar energy by reducing the costs and time to construct large solar farms and increasing their operational efficiencies.

One embodiment of the invention is a method for continuously constructing and operating a solar power facility. Unlike conventional solar farms, which are designed and built over a number of years and then operated until they reach the end of their useful lives, at which time they are dismantled, the present invention provides a method for continuously and perpetually designing, building, operating, and updating very large solar power facility so as to minimize planning, construction, and operation costs.

The solar facility of the present invention is first designed, sited, and permitted in a mostly conventional manner, except it is designed to be constructed in phases over a relatively long time period. For example, in one embodiment, a 25 GW facility is designed and scheduled for construction over a 25 year period, with approximately 1 GW of capacity installed per year.

Once the solar facility is designed, sited, and approved for construction, solar equipment, potentially including, but not limited to, solar panels, inverters, mounting structures, combiner boxes, cabling and electrical infrastructure, trackers, transformers, switchgear, monitoring and control systems, and energy storage are continuously manufactured at manufacturing facilities located next to or near the solar facility and installed as they are manufactured. Continuing the above example, 1 GW of solar panels and other necessary equipment may be manufactured and installed per year. These steps are repeated until the full capacity of the solar facility is built, which coincides with when the first installed solar panels and/or other equipment are likely to reach the end of their useful lives, which may be after 25 years. The depleted solar panels and/or other equipment are then replaced with newly built solar panels and recycled at the same site and used as raw materials for the construction of new solar panels and/or other equipment. Thus, the fabrication of solar panels and/or other equipment continues even after the solar facility is completed.

In accordance with other aspects of the invention, the performance of already installed solar equipment can be periodically monitored and compared to the performance characteristics and costs of newly fabricated equipment to determine when it is cost-effective to replace them.

The methods of the present invention provides numerous advantages. For example, by continuously constructing the solar equipment at the site of the solar power facility and installing the equipment as it is built rather than procuring solar equipment from China or elsewhere, economies of scale are achieved and costs associated with packing, shipping, storage, taxes, and tariffs are completely eliminated. Moreover, the throughput of solar equipment fabrication plants can be exactly matched to the capacity of the equipment installers so that manpower is perfectly balanced with little downtime and no staffing shortages.

Moreover, by using the solar equipment until it reaches the end of its useful life and then recycling it at the facility for use as raw materials for new solar equipment, waste is dramatically reduced and raw material costs are lowered. To further enhance efficiencies, the facility may receive and recycle solar equipment from other solar plants until the first of the solar equipment at the on-site plant reach the end of its useful life. Moreover, by monitoring the performance of the installed panels and other equipment and replacing them as soon as it is cost justifiable to do so, the solar facility maintains its peak performance.

The solar facility of the present invention may also be integrated with other renewable energy technologies, energy storage, or thermal power generation to achieve even further economies of scale and efficiencies.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of an exemplary solar power facility and an exemplary solar panel fabrication facility that may be used to construct and recycle solar panels and other equipment installed in the solar power facility in accordance with aspects of the present invention.

FIG. 2 is a flow diagram depicting exemplary steps in a method of the present invention.

FIG. 3 is a flow diagram depicting exemplary steps in another method of the present invention.

FIG. 4 is a schematic diagram of computer and communications equipment that may be used to implement embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

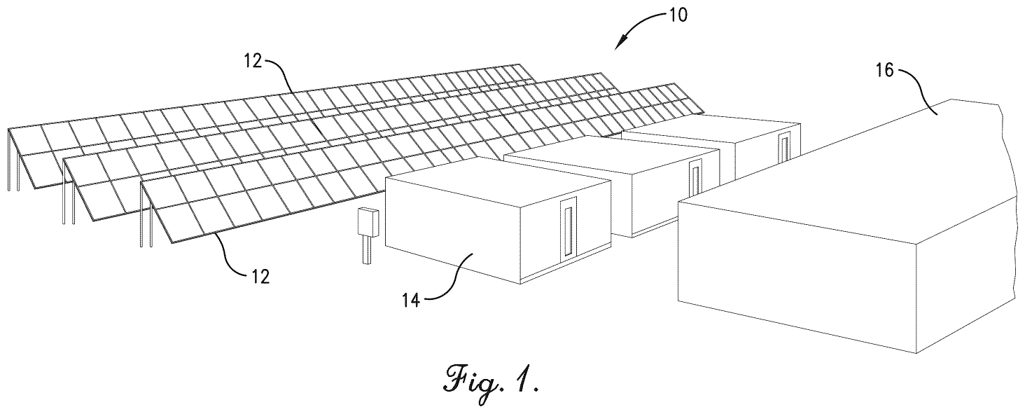

FIG. 1 depicts an exemplary solar power facility 10 that may be designed, sited, permitted, built, and operated in accordance with embodiments of the invention. The solar power facility may be of any size but is preferably a very large scale solar facility with a electricity generating capacity of at least 1 GW and preferably of 25 GW or more. The solar power facility includes a number of solar panels 12 and associated wiring and electronics and is coupled with an electrical grid in a conventional manner. The solar power facility may also include a number of battery-storage modules 14 and/or other energy storage components and inverters, mounting structures, combiner boxes, cabling and electrical infrastructure, trackers, transformers, switchgear, monitoring and control systems.

Also shown in FIG. 1 is a solar equipment fabrication facility 16 for fabricating the solar panels 12 and other equipment installed in the solar power facility 10. The solar equipment fabrication assembly 16 is positioned adjacent or very near the solar power facility so that the fabricated solar panels and other equipment may be quickly and relatively easily installed at the solar power facility as described herein.

Unlike conventional solar farms, which are designed and built over a number of years and then operated until they reach the end of their useful lives, at which time they are dismantled, the solar power facility 10 of the present invention is designed and built to capacity over a number of years and then continuously and perpetually operated, maintained, and partially replaced as needed so as to minimize planning, construction, and operation costs.

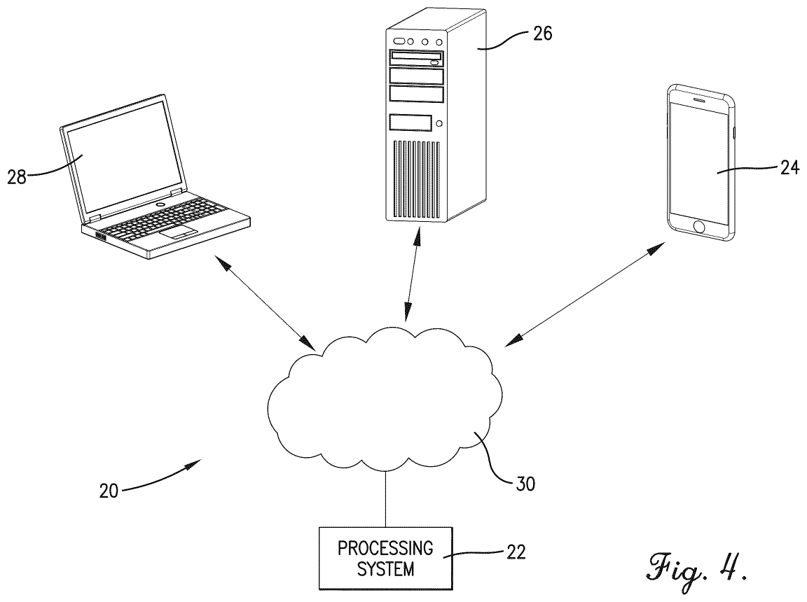

FIG. 4 shows an exemplary computer and communications system 20 that may implement aspects of the invention along with one or more computer programs for operating components of the system 20. One embodiment of the system 20 includes a processing system 22 that may be accessed by one more personal computing devices 24, 26, 28 via a communications network 30. The devices in the system 20 may be operated by any persons or entities.

The processing system 22 receives, stores, and provides access to the information described in connection with the methods described herein. The processing system 22 may also implement one or more computer programs for performing some of the functions described herein and may provide a web-based portal that can be accessed by the personal computing devices 14, 16, 18 and other devices.

Embodiments of the processing system 22 may include one or more servers running Windows; LAMP (Linux, Apache HTTP server, MySQL, and PHP/Perl/Python); Java; AJAX; NT; Novel Netware; Unix; or any other software system. The processing system 22 includes or has access to computer memory and other hardware and software for receiving, storing, accessing, and transmitting information as described below. The processing system 22 may also include conventional web hosting operating software, searching algorithms, an Internet connection, and is assigned a URL and corresponding domain name so that it can be accessed via the Internet in a conventional manner.

The personal computing devices 24, 26, 28 may be desktop computers, laptop computers, tablet computers, mobile phones, or similar devices. Each personal computing device preferably includes or can access an Internet browser and a conventional Internet connection such as a wireless broadband connection, DSL converter, or ISDN converter so that it can exchange data with the processing system 22 via the communications network 30.

The communications network 30 may be the Internet or any other communications network such as a local area network, a wide area network, or an intranet. The communications network 30 may include or be in communication with a wireless network capable of supporting wireless communications such as the wireless networks operated by AT&T, Verizon, or T-Mobile. The wireless network may include conventional switching and routing equipment. The communications network and wireless network may also be combined or implemented with several different networks.

The components of the system 20 illustrated and described herein are merely examples of equipment that may be used to implement embodiments of the present invention and may be replaced with other equipment without departing from the scope of the present invention. Some of the illustrated components of the system 20 may also be combined.

Embodiments of the present invention may also comprise one or more computer programs stored in or on computer-readable medium residing on or accessible by the processing system 22 or the personal computing devices 24, 26, 28. The computer programs may comprise listings of executable instructions for implementing logical functions in the computers and can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

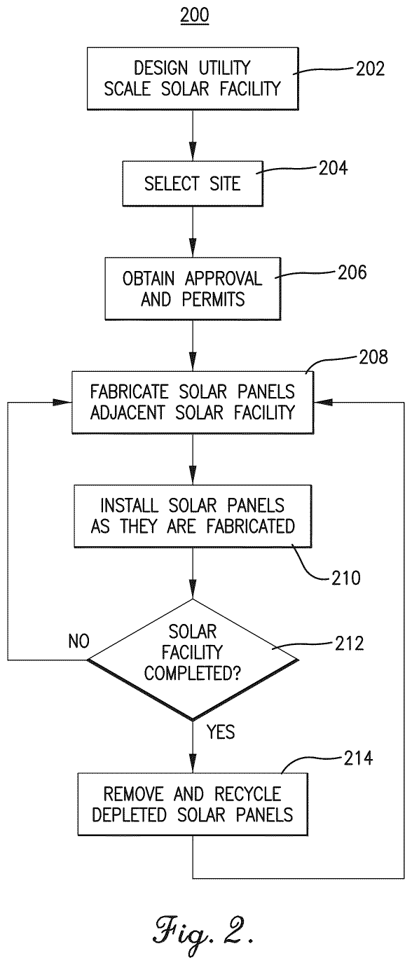

The flow chart show in FIG. 2 shows the functionality and operation of an implementation of the present invention. In this regard, some of the blocks of the flow chart may represent steps in a method 200 for continuously and perpetually designing, building, and operating a very large solar power facility. The blocks may also represent functions implemented by components of the computer and communications system 20. In some alternative implementations, the functions noted in the various blocks may occur out of the order depicted in the flow chart. For example, two blocks shown in succession may in fact be executed substantially concurrently, or the blocks may sometimes be executed in the reverse order depending upon the functionality involved.

As depicted in blocks 202, 204, and 206, the solar facility is first designed, sited, and permitted in a mostly conventional manner, except it is designed to be constructed in phases over a relatively long time period. For example, in one embodiment, a 25 GW facility is designed and scheduled for construction over a 25 year period, with approximately 1 GW of capacity installed per year. Once the solar facility is designed, sited, and approved for construction, solar panels and other equipment are continuously constructed at an equipment fabrication facility located next to the solar facility and installed as they are built as depicted in blocks 208 and 210. Continuing the above example, 1 GW of solar panels and other necessary equipment may be built and installed per year. These steps are repeated until the full capacity of the solar facility is built as depicted in block 212. In one embodiment, the construction and installation schedule for the solar facility is planned so that the facility is completed when the first solar panels that are installed reach the end of their useful lives. For example, the construction and installation schedule may be scheduled to be largely completed after 25 years, which is the approximate useful life of many solar panels. The depleted solar panels and/or other equipment are then replaced with newly built solar panels and/or other equipment and recycled at the same site and used as raw materials for the construction of new solar panels and/or other equipment as depicted in blocks 214, 208, 210. Thus, the fabrication of solar panels and/or other equipment indefinitely continues even after the solar facility is completed.

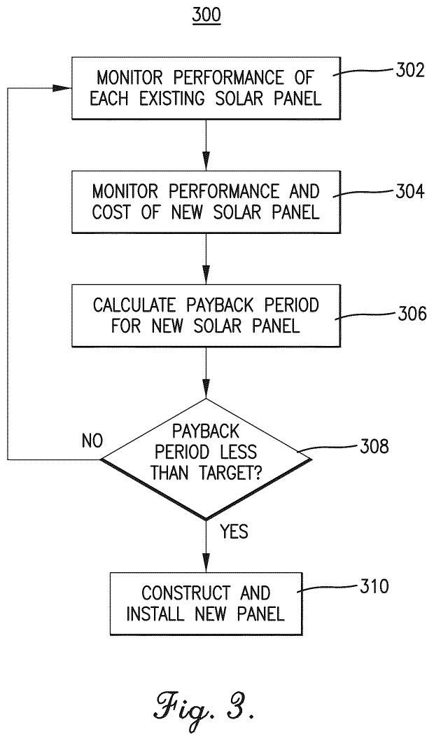

The flow chart shown in FIG. 3 shows the functionality and operation of another embodiment of the present invention. In this regard, some of the blocks of the flow chart may represent steps in a method 300 for continuously and perpetually designing, building, and operating a very large solar power facility. The blocks may also represent functions implemented by the computer and communications system 20. In some alternative implementations, the functions noted in the various blocks may occur out of the order depicted in the flow chart. For example, two blocks shown in succession may in fact be executed substantially concurrently, or the blocks may sometimes be executed in the reverse order depending upon the functionality involved.

The computer and communications system 20 along with conventional voltage, amperage, and resistance sensors first monitor the performance of each of the installed solar panels as depicted by block 302. The computer and communications system 20 then receives data regarding the performance and cost of newly fabricated solar panels as depicted in block 304. The computer and communications system 20 then determines if it is cost-effective to replace any of the existing solar panels with newly constructed solar panels as depicted in block 306. In one embodiment, the computer and communications system 20 determines a payback period for replacing each of the installed solar panels based on the performance and cost information described above. If the payback period for one of the installed solar panels is less than a threshold (such as 2-5 years) as depicted in block 308, the already installed solar panel is replaced with a newly fabricated solar panel as depicted in block 310. These same steps may be performed for other solar equipment.

The methods of the present invention provide numerous advantages. For example, by continuously constructing the solar panels and/or other equipment at the site of the solar power facility 10 and installing them as they are built rather than procuring solar panels and/or other equipment from China or elsewhere, economies of scale are achieved and costs associated with packing, shipping, storage, taxes, and tariffs are completely eliminated. Moreover, the throughput of the solar panel fabrication plant 12 can be exactly matched to the capacity of the panel installers so that manpower is perfectly balanced with little downtime and no staffing shortages. Moreover, by monitoring the performance of the installed panels and/or other equipment and replacing them as soon as it is cost justifiable to do so, the solar facility maintains its peak performance.

Continuing the example mentioned above, where a 25 GW solar power facility is designed, sited, and permitted and scheduled for completion over a 25 year period, a selected number of workers can be hired for both fabricating and installing 1 GW of equipment per year, so that 1/25th of the plant is fabricated and installed per year. This ensures a constant and predictable fabrication and installation schedule rather than the cyclical and largely unpredictable schedules typically experienced by solar equipment fabricators and installers. At the end of the 25th year, the plant is fully built out, but the solar panels and other equipment built and installed the first year are at or near the end of their useful lives, so they are removed and recycled and replaced with newly fabricated solar equipment. Thus, the fabrication and installation of the solar equipment never stops, and the fabrication and installation schedules and workloads are perfectly balanced, resulting in economies of scale and lower and more predictable labor costs. This also provides long-term, stable employment for US based solar panel fabricators and installers and allows them to work in the same facility for long periods of time, unlike current practices where fabricators are often in other countries and installers are required to travel from site to site as new projects are started and later completed.

Moreover, by using the solar equipment until it is at the end of its useful life and then recycling it at the facility for use as raw materials for new solar equipment, waste is dramatically reduced and raw material costs are lowered. To further enhance efficiencies, the facility may receive and recycle depleted solar equipment from other solar plants until the first of the solar equipment at the on-site plant become depleted. A grading process may be used to test equipment for possible recycling or reuse. Solar modules in particular may have useful remaining life. Equipment with a high enough grade may be “binned” and deployed in a manner to allow it to continue to operate. This could apply to inverters, batteries, piles, wiring, nuts, bolts, etc. One aspect of the invention that makes recycling and/or reuse more feasible is the elimination of restrictive warranties and guarantees when the panels are designed, constructed, and sold by different players in the supply chain.

The present invention can achieve additional optimization of labor resources across recycling, manufacturing and construction by taking into account weather, seasonality, daylight, etc. For example, because productivity of labor in the solar panel installation industry is often a function of temperature and other weather factors, more labor can be scheduled for indoor solar equipment construction during bad weather and more labor can be scheduled for outdoor panel installation during relatively good weather. Similarly, the perpetual construction and installation aspects of the present invention facilitate many labor management activities not typical in solar, such as local hiring, apprenticeships, training, career advancement, etc.

The present invention also allows dynamic optimization of resources such as supply chain resources, inventory resources, transportation costs, manufacturing, and interest costs so that each unit of kWh production installed has the lowest overall cost as measured by incremental $/kWh for each panel installed. Conventional solar power plants are generally optimized to produce the lowest cost on a $/kWh basis; however, this is done at the outset of project design and planning with limited opportunities for changes after construction starts. The present invention goes further by allowing for optimization on a continuous basis, potentially at an increment of each panel installed. For example, a significant input for manufacturing is electricity cost. The manufacturing and recycling operations of the present invention could be primarily operated when the output of the solar power plant is high or the electric grid has an abundance of electricity and the marginal cost of the energy is effectively zero or very low. Another example is that solar plants today must manage their supply chain primarily to achieve their construction schedule. The present invention allows for supply chain management in a dynamic manner to reduce costs such as buying materials when commodity prices are lower.

The present invention also allows for the adaptation of solar equipment design to achieve the best rate of return. For example, for conventional solar power facilities, solar panels are designed and constructed for maximum lifetimes, to be installed in all types of weather conditions, and transported across the world. Manufacturers provide very long warranties to cover liabilities that their products will not last at least 25 years. With the present invention, solar panels may instead be designed for lower cost, enhanced recyclability, reduced weight, and/or less than maximum lifespan so as to achieve a better cost balance.

The solar facility of the present invention may also be integrated with other energy technologies to achieve even further economies of scale and efficiencies. In one embodiment, the facility may be used to create hydrogen. Hydrogen is used in many industrial applications and is currently produced mainly from natural gas and other fossil fuels, making hydrogen production responsible for a great deal of CO2 emissions. Electrolytically produced hydrogen can replace fossil fuel produced hydrogen, but electrolytic hydrogen requires a large amount of electricity. The solar facility of the present invention can supply this electricity during periods of lower grid demand to produce electrolytic hydrogen cost effectively with no CO2 emissions. With the lower electricity costs achieved with the present invention, building electrolysers at the solar facility creates a low-cost supply option for hydrogen, even after considering the transmission and distribution costs of transporting the hydrogen from the facility to end-users. In a related embodiment, the solar facility of the present invention may also be used to create green ammonia by using the hydrogen produced from water electrolysis and nitrogen separated from the air, thus eliminating the CO2 emitted by traditional methods of producing ammonia. The present invention may be used in similar ways to produce other eFuels and to power direct air carbon capture equipment.

Solar facilities in accordance with aspects of the present invention may also be co-deployed with other energy projects. For example, a solar facility may be co-deployed with an oil and gas field to allow for dual land use. The solar facility may include and power a fugitive methane monitoring system within the oil and gas project so as to better monitor and mitigate emissions. Similarly, a solar facility may be paired with a stable qualified hydrogen plant and may provide for further “greening” of H2 by using energy from the solar facility to not just provide renewable energy but to also mitigate some of the negatives of hydrogen production. Similarly, a solar facility may be combined with other energy sources including storage and thermal power generation to create a self-contained power system that is not connected to the current electric grid. Such a system could provide low-cost, reliable, clean power to a wide variety of end uses such as data centers.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of any related issued patents and equivalents. The detailed description is to be construed as exemplary only and does not describe every possible embodiment since describing every possible embodiment would be impractical. Numerous alternative embodiments may be implemented, using either current technology or technology developed after the filing date of this patent application, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims in any related issued patent are not intended to be construed under 35 U.S.C. § 112(f) unless traditional means-plus-function language is expressly recited, such as “means for” or “step for” language being explicitly recited in the claim(s).

Although the invention has been described with reference to the embodiments described and illustrated herein, it is noted that equivalents may be employed, and substitutions made herein without departing from the scope of the invention as recited in the claims. Novel aspects of the invention may include the following:

1. A method for continuously constructing and operating a solar power facility, the method comprising:
a) designing the solar power facility;
b) obtaining governmental approvals for construction of the solar power facility;
c) fabricating solar equipment for the solar power facility at a solar equipment fabrication facility;
d) installing the solar equipment at the solar power facility as it is fabricated at the solar equipment fabrication facility;
e) repeating steps c) and d) until some of the installed solar equipment reaches the end of its useful life;
f) replacing the solar equipment that has reached the end of its useful life with newly fabricated solar equipment fabricated at the solar equipment fabrication facility; and
g) repeating step f) indefinitely.

2. The method of claim 1, wherein the solar power facility is designed and constructed to have a total capacity of over 1 GW.

3. The method of claim 1, wherein the solar power facility is designed and constructed to have a total capacity of over 25 GW.

4. The method of claim 1, wherein steps c), d), and e) continue for at least 10 years.

5. The method of claim 1, wherein steps c), d), and e) continue for at least 20 years.

6. The method of claim 1, further comprising recycling the solar equipment that has reached the end of its useful life at the solar equipment fabrication facility.

7. The method of claim 6, further comprising recycling solar equipment from other sites at the solar equipment fabrication facility until at least some of the solar equipment from the solar equipment fabrication assembly has reached the end of its useful life.

8. A method for continuously constructing and operating a very large scale solar power facility, the method comprising:
a) designing the solar power facility;
b) obtaining governmental approvals for construction of the solar power facility;
c) scheduling construction of the solar power facility over a multi-year period;
d) fabricating solar equipment for the solar power facility at a solar equipment fabrication facility;
e) installing the solar equipment at the solar power facility as it is fabricated;
f) repeating steps d) and e) until the end of the multi-year period and until some of the installed solar equipment reaches the end of its useful life;
g) replacing the solar equipment that has reached the end of its useful life with newly fabricated solar equipment;
h) recycling the solar equipment that has reached the end of its useful life and using materials from the recycling to fabricate additional solar equipment; and
i) repeating steps g) and h) indefinitely.

9. The method of claim 8, wherein the solar power facility is designed and constructed to have a total capacity of over 1 GW.

10. The method of claim 8, wherein the solar power facility is designed and constructed to have a total capacity of over 25 GW.

11. The method of claim 8, wherein steps c), d), and e) continue for at least 10 years.

12. The method of claim 8, wherein steps c), d), and e) continue for at least 20 years.

13. The method of claim 8, further comprising recycling the solar equipment that has reached the end of its useful life at the solar equipment fabrication facility.

14. The method of claim 13, further comprising recycling solar equipment from other sites at the solar equipment fabrication facility until at least some of the solar equipment from the solar equipment fabrication assembly has reached the end of its useful life.

15. A method for continuously constructing and operating a very large scale solar power facility, the method comprising:
a) designing the solar power facility;
b) obtaining governmental approvals for construction of the solar power facility;
c) scheduling construction of the solar power facility over a multi-year period;
d) fabricating solar equipment for the solar power facility at a solar equipment fabrication facility;
e) installing the solar equipment at the solar power facility as it is fabricated;
f) repeating steps d) and e) until the end of the multi-year period;
g) monitoring performance of the installed solar equipment;
h) monitoring performance and cost of newly fabricated solar equipment;
i) determining a payback period for replacing the installed solar equipment based on information gathered in steps g) and h):
j) if the payback period for the installed solar equipment is less than a threshold, replacing the installed solar equipment with newly fabricated solar equipment.

16. The method of claim 15, further comprising:
k) determining when some of the installed solar equipment reaches the end of its useful life;
l) replacing the solar equipment that has reached the end of its useful life with newly fabricated solar equipment;
m) recycling the solar equipment that has reached the end of its useful life and using materials from the recycling to fabricate additional solar equipment and;
n) repeating steps k), l), and m) indefinitely.

17. The method of claim 15, wherein the solar power facility is designed and constructed to have a total capacity of over 1 GW.

18. The method of claim 15, wherein the solar power facility is designed and constructed to have a total capacity of over 25 GW.

19. The method of claim 16, further comprising recycling the solar equipment that has reached the end of its useful life at the solar equipment fabrication facility.

20. The method of claim 19, further comprising recycling solar equipment from other sites at the solar equipment fabrication facility until at least some of the solar equipment from the solar panel fabrication assembly has reached the end of its useful life.
